(19) United States
(12) Patent Application Publication
(10) Pub. No.: US 2018/0261810 A1
(43) Pub. Date: Sep. 13, 2018

(54) COVER ELEMENT OF A BATTERY MODULE HOUSING, BATTERY MODULE HAVING SUCH A COVER ELEMENT AND METHOD FOR THE PRODUCTION THEREOF, AND BATTERY

(71) Applicant: Robert Bosch GmbH, Stuttgart (DE)

(72) Inventors: Ruben Jung, Stuttgart (DE); Maximilian Oscar Bader, München (DE); Stefan Grun, Kirchheim Teck (DE); Walter Jasch, Stuttgart (DE); Alexander Usselmann, Heidelberg (DE); Kerstin Koch, Schwieberdingen (DE)

(21) Appl. No.: 15/759,638

(22) PCT Filed: May 31, 2016
(86) PCT No.: PCT/EP2016/062296

§ 371 Date: Mar. 13, 2018

(30) Foreign Application Priority Data
Sep. 15, 2015 (DE) 10 2015 217 644.4

(51) Int. Cl. H01M 2/10; H01M 2/04; H01M 2/20; H01M 10/0525; H01M 10/058

(52) U.S. Cl. CPC H01M 2/1077; H01M 2/0434; B60L 11/1879; H01M 10/0525; H01M 10/058; H01M 2/206

(57) ABSTRACT

The invention relates to a cover element of a battery module housing (2) which is designed to accommodate a plurality of battery cells (6), wherein the cover element (1) has a housing wall (7) with a first surface (8) and a second surface (9) arranged on an opposite side of the housing wall (7) from the first surface (8), and the cover element (1) of the battery module housing (2) is configured such that, in a mounted state, the first surface (8) is arranged next to an environment (11) of the battery module housing (2) and the second surface (9) is arranged next to the battery cells (6) of the battery module, wherein at least one electric element (12) or electronic element (13) is connected to the second surface (9) and/or at least one electric element (12) or electronic element (13) is integrated into the housing wall (7) of the cover element (1) such that the electric or electronic components (15) thereof are arranged on the second surface (9), wherein the housing wall (7) covers the at least one electric element (12) or electronic element (13) in the direction of the environment (11) in those regions (16) of the first surface (8) which are arranged opposite those regions of the second surface (9) that are covered by the at least one electric element (12) or electronic element (13).

### BACKGROUND OF THE INVENTION

The invention relates to a cover element of a battery module housing. A battery module having such a cover element is also the subject matter of the present invention. In addition, the invention relates to a method for producing a battery module having such a cover element and to a battery.

It is known from the prior art that batteries, such as particularly lithium ion batteries, consist of at least one battery module or also advantageously a plurality of battery modules. Furthermore, a battery module has a large number of individual battery cells which are connected to one another to form the battery module, wherein the individual battery cells can be connected to one another in series or in parallel.

### SUMMARY OF THE INVENTION

A cover element of a battery module according to the invention has the advantage that at least one electric or electronic element is protected from outside influences during the operation of the battery module. An adherence of particles on the at least one electric or electronic element can particularly be reduced. In addition, damage due to mechanical stress can particularly be reduced. This enables the service life of the at least one electric and electronic element to be lengthened as well as the service life of the battery module which is associated therewith. Moreover, the at least one electric component or the at least one electronic component is arranged after mounting in the battery module such that gravity additionally makes the accommodation of particles more difficult.

According to the invention, a cover element of a battery module housing is provided. The battery module housing is designed to accommodate a plurality of battery cells. As a result, the cover element has a housing wall having a first surface and a second surface. The second surface is arranged on a side of the housing wall opposite to the first surface. The cover element of the battery module housing is furthermore configured such that, in a mounted state, the first surface is arranged next to an environment of the battery module housing and the second surface is arranged next to the battery cells of the battery module. In so doing, at least one electric or electronic element can be connected to the second surface. Furthermore, at least one electric or electronic element can be integrated into the housing wall of the cover element such that the electric or electronic components thereof are arranged on the second surface. The housing wall covers the at least one electric or electronic element in the direction of the environment in those regions of the first surface which are arranged opposite those regions of the second surface that are covered by the at least one electric element or electronic element.

An additional cover element can particularly be omitted as a result of the connection of the at least one electric element or the at least one electronic element to the cover element or the integration thereof in the cover element. In addition, the size and thus the costs of the cover element can thereby be reduced.

The at least one electric element can particularly be a cell connector, a cell contacting element or an electric busbar. An electric element refers in this case to an element which conducts the electric current and thus has a defined resistance. As a result, it is possible to protect the at least one electric element of a battery module from outside influences, such as, for example, the ingress and attachment of particles, by means of a connection to the second surface of the cover element of the battery module housing or an integration into the cover element so that the electric components are arranged on the second surface. In addition, the housing wall can provide for an electric insulation of the at least one electric element vis-à-vis the environment and thus increase the safety and reliability of the system.

In addition, the at least one electronic element can be a circuit board, a resistor conductor rail, a relay, an electromechanical component or a fuse. An electronic element refers in this case to an element which can control and/or monitor the battery module by actively influencing the electric current flow. An attachment of particles leads to a reduction in the service life or a reduction in performance particularly in the case of components of the circuit board. The probability of an attachment of particles can thus be reduced by means of a connection of the at least one electronic element to the second surface of the cover element of the battery module housing or also an integration into the cover element so that the electronic components are arranged on the second surface. As a result, further measures for protecting the electronic components from an attachment of particles can be omitted under certain circumstances. The housing wall furthermore protects the at least one electronic element from mechanical influences.

It is expedient if the cover element has at least one voltage tap arranged on the first surface. The cover element particularly has a positive voltage tap and a negative voltage tap. The cover element is preferably configured such that the entire voltage delivered by the battery cells of the battery module can be tapped at the positive voltage tap and the negative voltage tap. To this end, the voltage taps of the individual battery cells are advantageously connected via cell connectors and/or conductor rails to one another and to the at least one voltage tap which is arranged on the first surface. The battery cells can thereby be connected in series or in parallel. It is additionally possible to combine the series circuitry and the parallel circuitry.

Provision can be made according to one aspect of the invention for the housing wall to have at least one opening. The at least one opening is designed for receiving a voltage tap of a battery cell of the battery module. The at least one opening can be closed on the side of the first surface by a covering member. This has the advantage that the cover element can be connected to the housing of the battery module and the battery taps of the battery cells are nevertheless accessible from the environment of the battery module. It is therefore possible to reliably connect a voltage tap to a cell connector. As a result, a direct contacting of the cell connector to the voltage tap of the battery cell is possible after the cover element has been connected to the battery module. In addition, the cell connector is particularly, as already explained above, connected to the cover element or integrated into the same, wherein the cell connector furthermore has a connecting region that is not connected to the cover element or integrated into the same, which is designed to connect to a voltage tap. The voltage tap and the connecting region of the cell connector can then be connected to one another, for example by means of laser welding. In doing so, it is expedient for the connecting region of the cell connector to be disposed within the at least one opening or in the region of the at least one opening on the side of the second surface so that a simple connection is made possible. After the voltage tap and the cell connector are connected to one another, the at least one opening, in which the voltage tap that is connected to the cell connector is now disposed, can be closed by means of a covering member. The voltage tap of the battery cell can thus be protected from outside influences, such as mechanical stresses and the ingress of dirt or respectively particles. In particular, the connection between the cell connector and the voltage tap of the battery cell is thereby protected from outside influences. The covering member is advantageously formed from an electrically insulating material or comprises an electrically insulating material. The covering member can, therefore, insulate the voltage tap from the environment of the battery module and thereby increase the safety and reliability of the system.

It is advantageous if the cover element has a seal that is arranged circumferentially on said cover element. In so doing, the cover element is configured such that it can be reversibly or irreversibly connected to the battery module. Hence, in a mounted state, the seal seals off an interior space that accommodates the battery cells from the environment of the battery module. In this context, an irreversible connection refers to the fact that the cover element and the housing of the battery module are connected to one another by a cohesive joining procedure such as welding, soldering or adhesive bonding. A reversible connection refers in this context to the fact that the cover element and the housing of the battery module are connected to one another by a detachable connection such as screws or by clips. The clipping-on procedure can be carried out such that the clips break off upon opening the cover element and a deliberate opening can, for example, thereby be proven.

It is expedient if a positioning element is furthermore connected to the second surface, the positioning element being designed to attach the at least one electric element or the at least one electronic element to the second surface. The positioning element is configured such that the attachment takes place as a result of the material of the positioning element being melted. This enables the electric element or respectively the electronic element to be connected to the second surface in a simple manner, in particular also prior to the connection of the cover element to the battery module housing. Melting refers here to the fact that the positioning element is heated to a temperature which lies above the melting point of the material of the positioning element, whereby the shape of the positioning element can be changed.

In addition, it is also expedient if the cover element has at least one attachment means designed to fasten the cover element to the battery module housing. The attachment means can thereby be connected to the battery module housing. The attachment means can particularly be an opening, a projection or a detent element. A connection can thereby be established between the cover element and the battery module housing in a simple manner. Complicated manufacturing processes for the cohesive connection between the cover element and the battery module housing as, for example, welding can particularly be omitted.

The production of a battery module can be simplified by means of an embodiment of a cover element according to the invention. The production of the series and/or parallel circuitry of the battery cells as well as the contacting thereof by means of a circuit board is particularly simplified during mounting because electronic elements can already be integrated into the cover element. In addition, it is possible to connect or respectively integrate the electric and/or electronic elements, which are required for the open-loop and/or closed-loop control of a battery module as well as for the interconnection of the battery cells, to the cover element or respectively into said cover element and to interconnect said electric and/or electronic elements already prior to mounting the battery module. The installation effort and costs can consequently be reduced in comparison to a conventional installation, i.e. an interconnection of battery cells already arranged in the housing because the cover element is not yet mounted and is thus easily accessible for mounting steps. The reduced weight of the cover element furthermore simplifies handling during production.

After the arrangement of the cover element, this single mounting step can furthermore only include the connection of the voltage taps of the battery cells to the cell connectors as well as the covering of the openings using a covering member.

The invention further relates to a method for producing a battery module which has a cover element according to the invention that is described above. To this end, the battery cells are arranged in a housing in a first step and the housing is closed using the cover element is such a way that the battery cells are electrically connected to one another in series or in parallel. In particular, the cover element can further have an opening designed to receive a voltage tap of a battery cell. In this case, the second step further includes receiving the voltage tap of the battery cell of the battery module in the at least one opening and the connection of the voltage tap to the cell connector.

It is advantageous if the at least one electric element or the at least one electronic element is furthermore attached to the second surface of the cover element prior to the second step. The positioning element is melted, i.e. heated to a temperature which lies above the melting point of the material of the positioning element, in order to attach the at least one electric element or the at least one electronic element to the second surface. The electric element or respectively the electronic element has at least one opening, and the positioning element has a first section and a second section after the melting process, i.e. in a state in which the electric element or respectively the electronic element is attached to the second surface. The first section of the positioning element is then disposed so as to extend in the opening and is connected to the second surface of the cover element. The second section of the positioning element is arranged outside of the opening and contacts at least partially a surface of the electric element or respectively the electronic element.

This ensures that the electric element or respectively the electronic element is attached to the second surface of the cover element.

It is furthermore advantageous if, in the second step, the attachment means of the cover element continues to be connected to the battery module housing, wherein the connection is formed.

The invention further relates to a battery module, which has a cover element as described above or is produced by a method that is likewise described above.

A battery module according to the invention can be used for batteries in a mobile application, particularly in electric vehicles and E-bikes, and for batteries for use in a stationary operation.

### BRIEF DESCRIPTION OF THE DRAWINGS

Exemplary embodiments of the invention are depicted in the drawings and explained in detail in the following description.

In the drawings:

FIG. 1 shows a schematic description of a cover element according to the invention;

FIG. 2 shows an embodiment of a cover element according to the invention in a perspective top view;

FIG. 3 shows an embodiment of a cover element according to the invention having a covering member in a perspective top view;

FIG. 4 shows an embodiment of a cover element according to the invention in a perspective view from below;

FIG. 5 shows a cutout of a cover element according to the invention having an opening in a perspective view from below;

FIG. 6 shows a further embodiment of a cover element according to the invention having positioning elements in a perspective view from below;

FIGS. 7a to 7c show an option for attaching an electrical element or an electronic element to the cover element by remelting a positioning element;

FIG. 8 shows an embodiment of a cover element according to the invention having attachment means in a perspective top view;

FIG. 9 shows an embodiment of a battery module housing having attachment means in a perspective top view;

FIG. 10 shows an embodiment of a battery module housing having further attachment means in a perspective view; and

FIG. 11 shows a cover element connected to the battery module housing.

### DETAILED DESCRIPTION

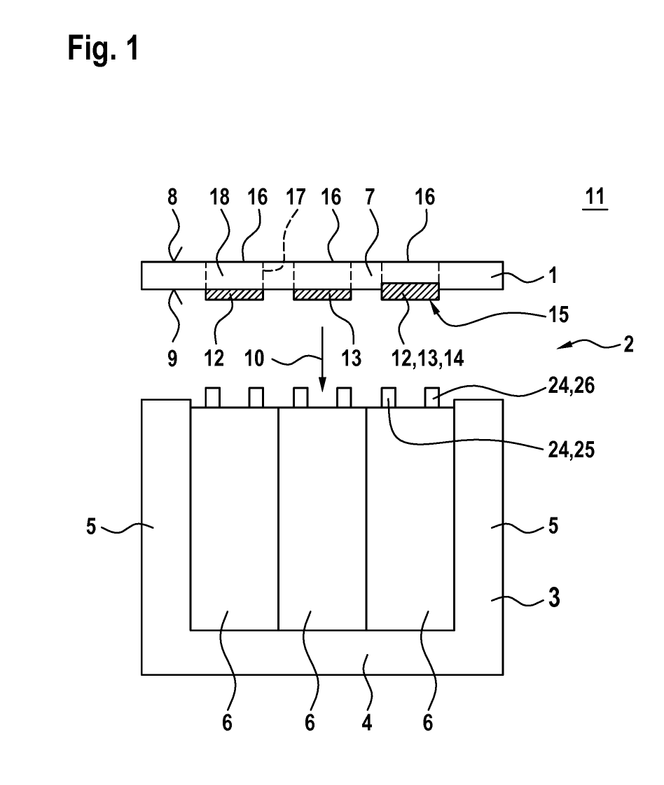

FIG. 1 shows schematically a depiction of an inventive cover element 1 of a battery module housing 2.

Besides the cover element 1, the battery module housing 2 has a casing 3. The casing 3 has substantially a casing bottom 4 and a plurality of side walls 5. FIG. 1 additionally shows the battery module housing in a side view, wherein the front side wall 5 is not shown in order to be able to discern the interior of the housing 3.

The battery module housing 2 is designed to receive a plurality of battery cells 6. In FIG. 1, three battery cells 6 are accommodated in the battery module housing 2, in particular in the casing 3. Because only one cover element 1 according to the invention is intended to be described schematically with the aid of FIG. 1, it goes without saying that the design of the casing 3 shown there and the number of battery cells 6 are not to be considered as restrictive for the invention. The battery cells 6 each have a voltage tap 24, in particular a positive voltage tap 25 and a negative voltage tap 26.

As shown in FIG. 1, the cover element 1 has a housing wall 7. The housing wall 7 has a first surface 8 and a second surface 9. It is furthermore shown in FIG. 1 that the second surface 9 is arranged on an opposite side of the housing wall 7 from the first surface 8. The reverse is, of course, also true in this case.

In order to couple the cover element 1 to the casing 3, the cover element 1 is moved in the direction 10 shown without rotating the cover element 1. As a result, the first surface 8 is arranged next to an environment 11 of the battery module housing 2. In addition, the second surface 9 is thereby arranged next to the battery cells 6 of the battery module.

Particularly at least one electric element 12 is connected to the second surface 9. Furthermore, particularly at least one electronic element 13 is connected to the second surface 9. It is also additionally possible for the at least one electric element 12 or the at least one electronic element 13, as is shown with the reference number 14, to be integrated into the housing wall 7. In doing so, the integration is configured such that the electric or electronic components 15 of the at least one electric element 12 or the at least one electronic element 13, which components are to be identified with the reference number 15, are arranged on the second surface 9.

The at least one electric element 12 or the at least one electronic element 13 covers the second surface 9, as can be seen in FIG. 1, at least in certain sections. At least one region 16 of the first surface 8 is arranged opposite to this region of the second surface 9 that is covered in this way. The intersections of the dashed lines 17 shown in FIG. 1 and the surface 8 are used to illustrate the boundary of the region 16. In those regions 16 of the first surface 8, the housing wall 7 covers the at least one electric element 12 or the at least one electronic element 13 in the direction of the environment 11. Particularly the volume that lies within the dashed lines 17 and the first surface 8 as well as the second surface 9 and is at least partially filled by the material of the housing wall 7 covers the at least one electric element 12 or the at least one electronic element 13 in the direction of the environment 11. The dashed line 17 is thus arranged perpendicularly to the second surface 9. It is furthermore possible for the dashed line 17 to also be arranged at an angle to the first surface 9.

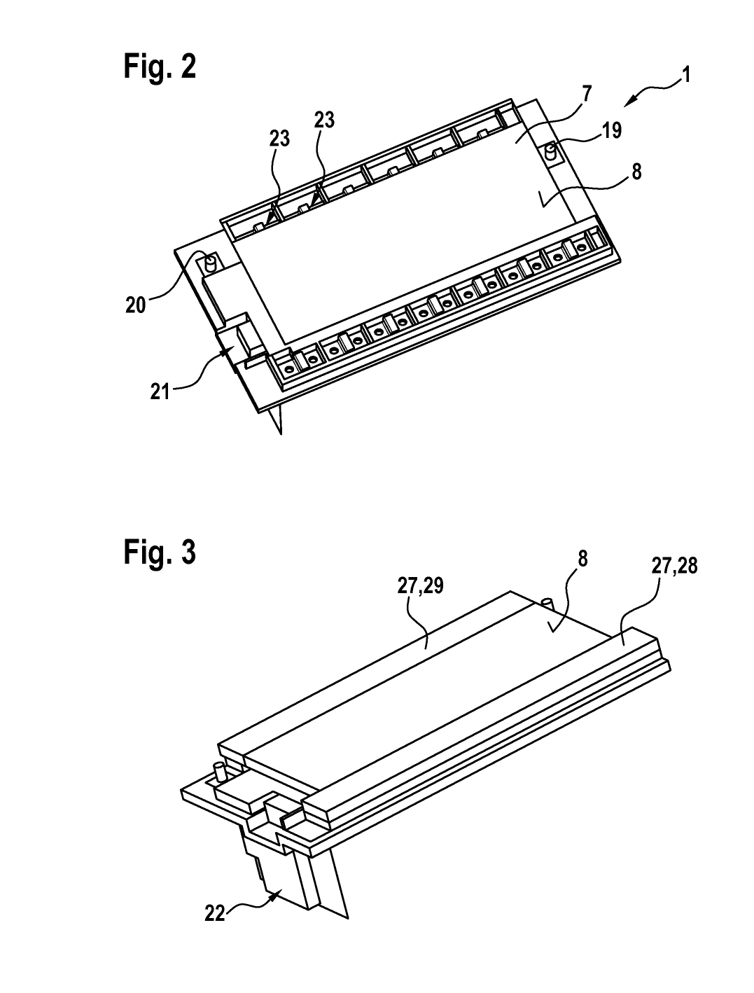

FIG. 2 shows an embodiment of a cover element 1 according to the invention in a perspective top view, wherein the casing 3 of the battery module housing 2 including the battery cells 6 arranged therein is not shown.

The first surface 8 can be seen in FIG. 2. In addition, the cover element 1 has a positive voltage tap 20 arranged on the first surface 8. The cover element 1 furthermore has a negative voltage tap 19 arranged on the first surface 8. The positive voltage tap 20 and the negative voltage tap 19 serve a consumer for the purpose of tapping the entire voltage of the battery cells 6, in particular the positive or respectively negative voltage.

It can furthermore be seen from FIG. 2 that the cover element 1 has a plug-in element 21 which is used as an interface for connecting the battery module to a vehicle that is not depicted here.

The housing wall 7 of the cover element 1 of the battery module housing 2 has at least one opening 23. In particular, the cover element 1 shown in FIG. 2 has, for example, thirteen openings 23. The at least one opening 23 is designed to receive a voltage tap 24. The opening 23 is particularly designed to receive a positive voltage tap 25 and a negative voltage tap 26. The at least one voltage tap 24, 25, 26 can be connected to a cell connector 34, which will be described later.

FIG. 3 shows an embodiment of an inventive cover element 1 having a covering member 27 in a perspective top view.

The cover element 1 shown in FIG. 3 corresponds to the cover element 1 shown in FIG. 2, wherein the only difference is that the one covering member 27 closes the at least one opening 23 on the side of the first surface 8. A first covering member 28 particularly closes seven openings 23, which can be seen in the comparison of FIGS. 2 and 3. A second covering member 29 particularly closes six openings 23, as can be seen in the comparison of FIGS. 2 and 3. The at least one covering member 27, 28, 29 is formed from an electrically insulating material or comprises an electrically insulating material.

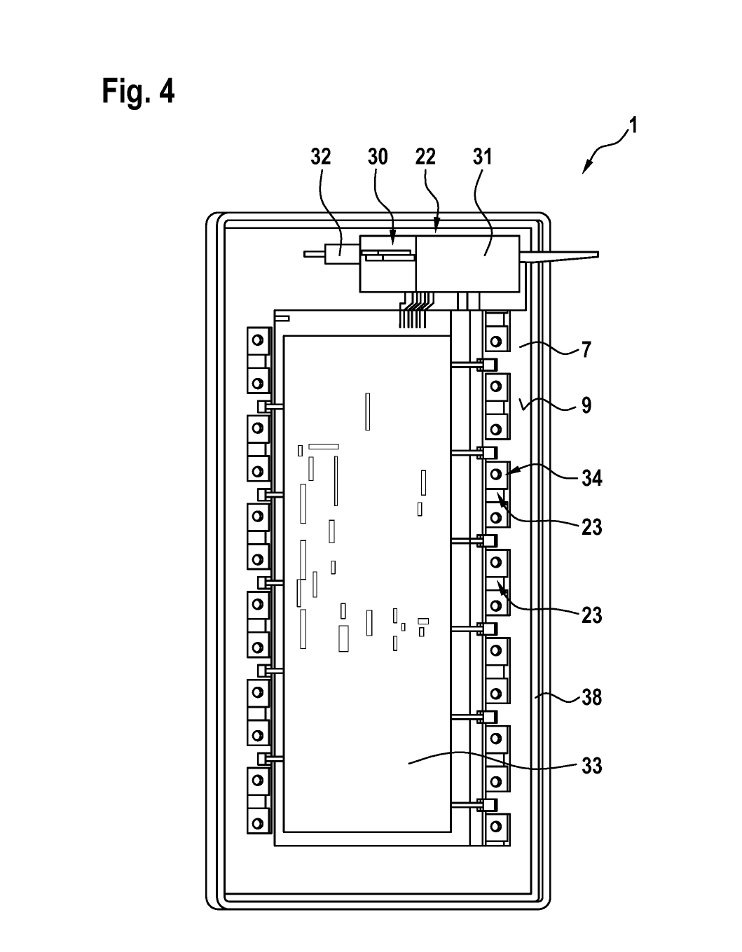

In addition, the depiction of the cover element in FIG. 3 in comparison to FIG. 2 was rotated so that it can be seen in FIG. 3 that the cover element 1 has a control element 22. The control element thereby has a fuse 30 and a relay 31, wherein their configuration is described below in the description of FIG. 4.

FIG. 4 shows an embodiment of a cover element 1 according to the invention in a perspective depiction from below.

As a result, the second surface 9 of the housing wall 7 can be seen in FIG. 4 in contrast to FIGS. 2 and 3. Electric elements 12 and electronic elements 13 are arranged on the surface 9 of the housing wall 7. Said electric and electronic elements will be described in detail below.

As can already be seen in FIG. 3, the cover element 1 has a control element 22. The control element has a fuse 30 and a relay 31. The relay 31 is, in particular, is reversibly connected to the cover element 1. The relay 31 can, for example, be connected to the cover element 1 by means of a clip. Furthermore, this connection can also be embodied in an irreversible manner if no replacement of parts is required. The fuse 30 is preferably welded to the relay 31. Moreover, the fuse 30 is connected to a positive conductor rail 32 by means of welding.

In addition, a circuit board 33 is connected to the second surface 9 of the housing wall 7 of the cover element 1 or is integrated into the housing wall 7.

It can furthermore be seen in FIG. 4 that the housing wall 7 has at least one opening 23. The housing wall 7 of the cover element shown in FIG. 4 has particularly thirteen openings 23. It is clear from the comparison of FIGS. 2 and 4 that the at least one opening 23 is formed to run continuously through the housing wall 7.

The connections between the conductor rails and the relay 31 and between the conductor rails and the busbar can be carried out in a pre-mounting step.

FIG. 4 furthermore shows that the cover element 1 has a seal 38 arranged on the second surface 9 of the housing wall. In doing so, the seal is arranged circumferentially on the first surface 9. As a result, the seal can seal an interior space of the battery module from the environment 11. A seal 38 can be omitted if the interior space of the battery module can be sealed differently. In the case of an adhesively bonded connection of the cover element 1 to the housing 3, the adhesive can, for example, serve as a seal.

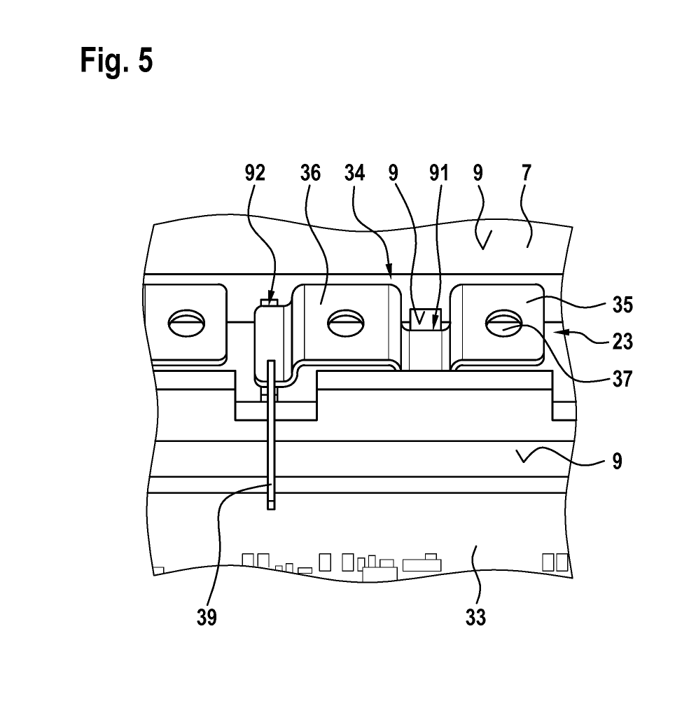

A cell connector 34 is arranged in the at least one opening 23 of the housing wall 7 already prior to the cover element 1 being connected to the housing 2. In doing so, the cell connectors 34 can be reversibly connected, such as designed to be clipped, to the cover element 1. The following description with regard to FIG. 5 shall clarify the connection of the cell connector 34 to a voltage tap 24, 25, 26.

FIG. 5 shows a cutout of a cover element 1 having an opening 23 in a perspective view from below.

The circuit board 33 can partially be seen in FIG. 5. Furthermore, the second surface 9 of the housing wall 7 can be seen.

The cell connector 34 is connected to the second surface 9 of the housing wall 7 in certain regions, as the reference numbers 91 and 92 are supposed to illustrate. The cell connector 34 particularly has a first side 35, which is designed to connect to a positive voltage tap 25 of a battery cell 6. The cell connector 34 particularly has a second side, which is designed to connect to a negative voltage tap 26 of a battery cell 6.

The first side 35 and/or the second side 36 of the cell connector 34 particularly have in each case an opening 37. The opening 37 is designed for the purpose of receiving a positive voltage tap 25 or respectively a negative voltage tap 26. Therefore, the at least one voltage tap 24, in particular the positive voltage tap 25 or the negative voltage tap 26, is accommodated in the opening 23 of the housing wall 7 of the cover element 1 and in the opening 37 of the first side 35 or respectively the second side 36 of the cell connector 34 when connecting the cover element 1 to the housing 2. Because the opening 23 of the housing wall 7 is accessible from the environment 11 of the battery module housing 2, a connection, in particular by means of laser welding, can be established between the at least one voltage tap 24, in particular of the positive voltage tap 25 or the negative voltage tap 26, and the cell connector 34, in particular the first side 35 or the second side 36. As shown in FIG. 3, the opening 23 to the environment 11 is then advantageously closed by a covering member 27, 28, 29.

Other embodiments of the cell connector 34, which do not have an opening 37, are, in particular, also possible.

In addition, it can be seen in FIG. 5 that the circuit board 33 and the cell connector 34 are connected by a cell contacting element 39. The connection between the cell contacting element 39 and the circuit board as well as between the cell contacting element 39 and the cell connector 34 can, for example, be established by means of laser bonding.

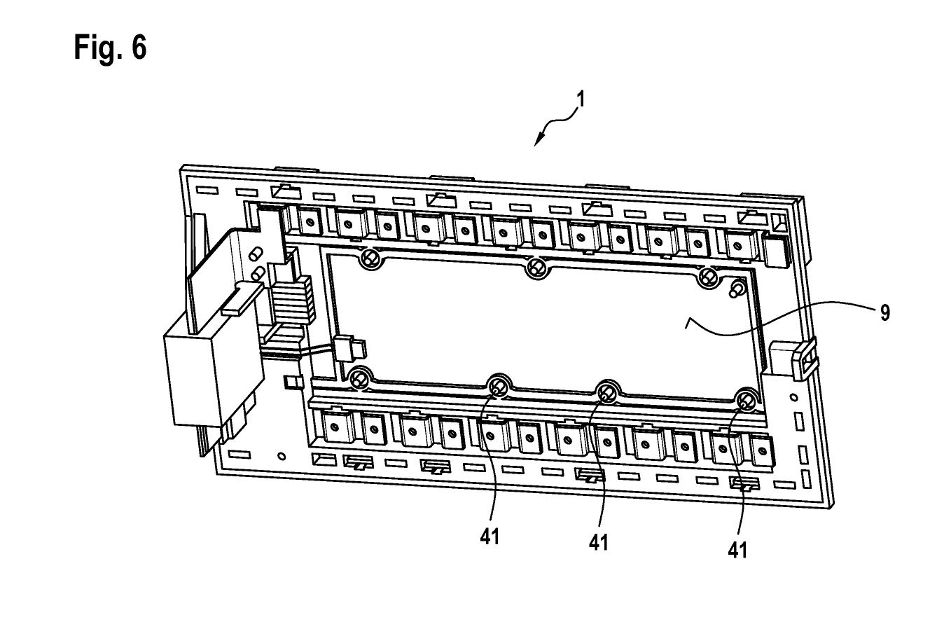

FIG. 6 shows a further embodiment of a cover element 1 according to the invention in a perspective view from below.

The further embodiment of the cover element 1 shown in FIG. 6 comprises positioning elements 41. The positioning elements 41 are arranged on the second surface 9 and are particularly connected to said second surface 9 of the cover element 1. The positioning elements 41 are designed to attach the at least one electric element 12 or the at least one electronic element 13 to the second surface 9. The positioning elements shown in FIG. 6 are preferably designed to attach an electronic circuit board.

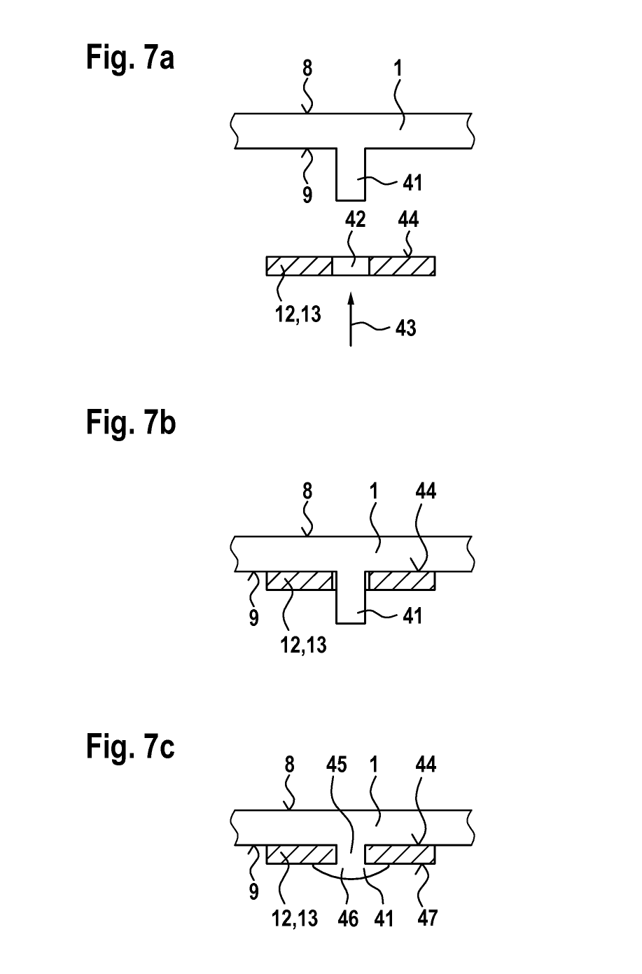

With the aid of FIGS. 7a to 7c, the attachment of the at least one electric element 12 or the at least on electronic element 13 to the second surface 9 by remelting the positioning elements 41 is described.

FIG. 7a shows a cutout of a cross-section of the cover element 1, a positioning element 41 being arranged on the second surface 9, wherein the positioning element 41 is particularly connected to the second surface 9. The positioning element 41 is shown in state that is not yet melted.

The FIG. 7a shows further the electric element 12 or respectively the electronic element 13, which is to be attached to the second surface 9 of the cover element 1. The electric element 12 or respectively the electronic element 13 has an opening 42, which is designed such that the electric element or the electronic element 13 can be pushed in the direction 43 shown in the direction of the cover element 1 so far until a contact surface 44 of the electric element 12 or respectively the electronic element 13 at least partially contacts the second surface 9 of the cover element 1. In other words, this means that cross-sectional surfaces of the opening 42 arranged perpendicularly to the direction 43 shown are larger than cross-sectional surfaces of the positioning element 41 arranged perpendicularly to the direction 43 shown. The positioning element 41 is thus disposed so as to at least partially extend in the opening 42 after the electric element 12 or respectively the electronic element 13 has been pushed onto said positioning element 41, which is shown in FIG. 7b. FIG. 7b thus shows the arrangement immediately before the positioning element 41 is remelted and after the electric element 12 or respectively electronic element 13 was pushed in the direction shown 43 in the direction of the cover element 1.

In order to attach the electric element 12 or respectively the electronic element 13, the positioning element 41 is heated to a temperature which lies above the melting point of the material of the positioning element 41. Hence, the positioning element 41 can be deformed due to the force of gravity or a manually applied force. At this point, it should be noted that the gravitational force acts in the direction 43 shown.

FIG. 7c shows an electric element 12 or respectively an electronic element 13 attached to the second surface 9 of the cover element 1. In doing so, the positioning element 41 has a first section 45 which is disposed so as to extend in the opening 42. The first section is also connected to second surface 9 of the cover element 1. The positioning element 41 further has a second section 46 which is arranged outside of the opening 42 and is connected to the first section 45. The second section 46 contacts at least partially a surface 47 of the electric element 12 or respectively the electronic element 13, wherein the surface 47 is preferably disposed on a side of the electric element 12 or respectively the electronic element 13 that lies opposite to the contact surface 44. In other words, this means that the cross-sectional surface of the positioning element 41 perpendicular to the direction 43 shown in the level section of the contact surface 47 is larger than the cross-sectional surface of the opening 42, whereby the electric element 12 or respectively the electronic element 13 is attached to the second surface 9.

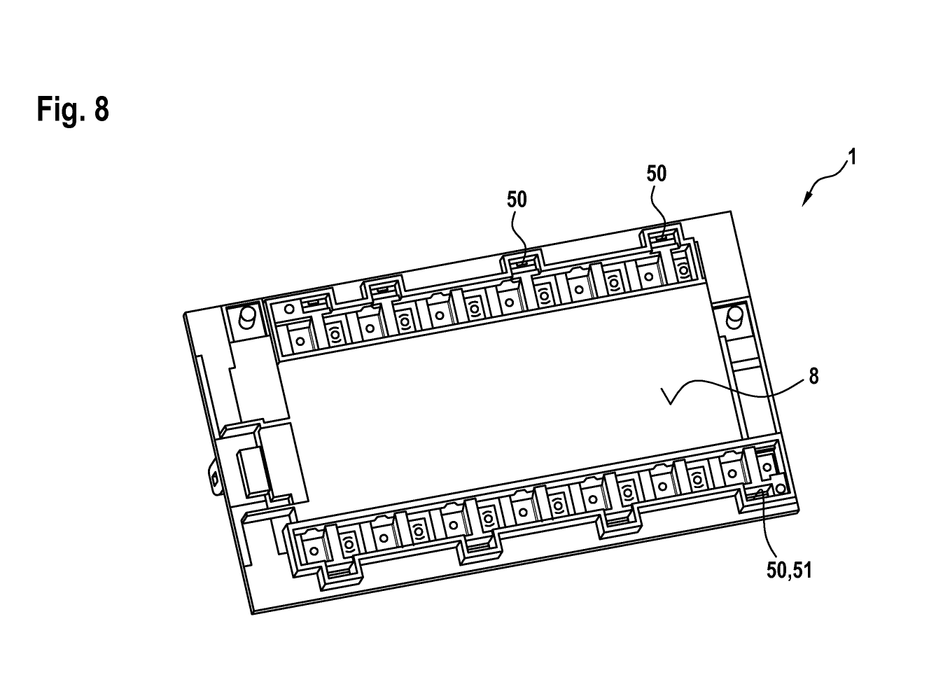

FIG. 8 shows a perspective top view of an embodiment of a cover element 1 according to the invention, wherein the cover element 1 shown in FIG. 8 has attachment means 50.

The attachment means 50 are configured as openings 51 and are designed to connect the cover element 1 to a battery module housing 2.

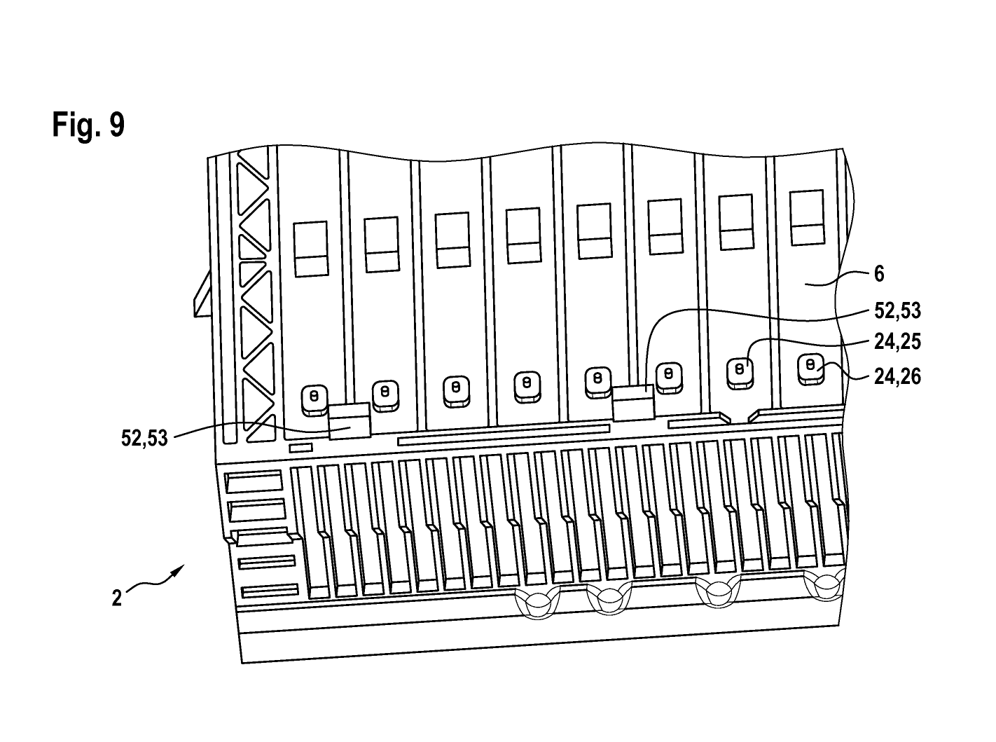

FIG. 9 shows a battery module housing 2 in which a plurality of battery cells 6 are accommodated. The battery cells 6 each have a voltage tap 24, in particular a positive voltage tap 25 and a negative voltage tap 26. Furthermore, the battery module housing 2 shown in FIG. 9 has attachment means 52. The attachment means 52 of the battery module housing 2 are designed as detent elements 53.

The attachment means 50 of the cover element 1 are connected to the attachment means 52 of the battery module housing 2 in order to reversibly connect the cover element 1 shown in FIG. 8 to the battery module housing 2 shown in FIG. 9. In doing so, the detent elements 53 especially engage in the openings 51 so that the detent elements 53 can prevent the cover element 1 from lifting off, i.e. from displacing in a direction perpendicular to the first surface 8. This means that the detent elements 53 have a first section and a second section. The first section is connected to the battery module housing 2a and is disposed so as to extend at least partially in the opening 51 of the cover element 1. The second section of the detent element 53 is disposed on the outside of the opening 51 and has a projection, wherein the projection at least partially contacts the first surface 8 of the cover element 1. The reversible connection is preferably configured such that the detent elements can be clipped into or latched into the openings 51. This means that the detent elements 53 can be temporarily deformed during the connection process in order to engage in the openings and subsequently return to their original form.

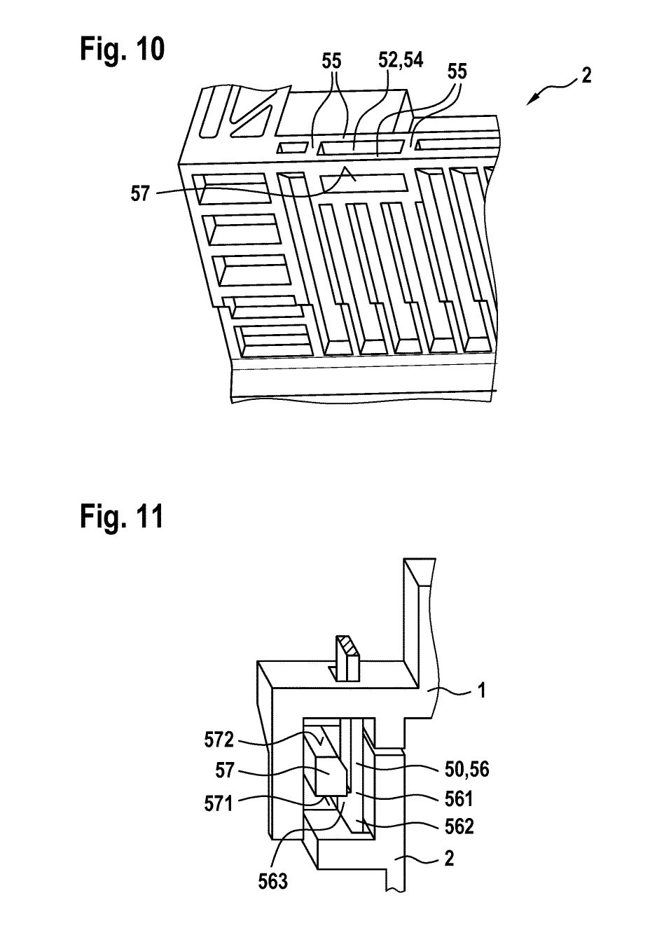

FIG. 10 shows a further embodiment of the battery module housing 2 having an attachment means 52, wherein, in the exemplary embodiment shown in FIG. 10, the attachment means 52 of the battery module housing 2 is designed as an opening 54 in contrast to the exemplary embodiment shown in FIG. 9. The opening 54 is delimited by four housing walls 55.

FIG. 11 shows a sectional view of a cover element 1 and a battery module housing 2 according to FIG. 10, which are connected to one another. In doing so, the cover element 1 has an attachment means 50 which is designed as a detent element 56. The detent element 56 has a first section 561, which is connected to the cover element 1, in particular to the second surface 9 and is disposed so as to at least partially extend in the opening 54 of the battery module housing 2. The detent element 56 furthermore has a second section 562, which is disposed outside of the opening 54, and a projection 563. The projection 563 at least partially contacts a surface 571 of one of the housing walls 55, which forms the opening 54. The one of the housing walls 55, which comprises the surface 571 that is at least partially contacted by the projection 563, is denoted in each case in FIGS. 10 and 11 with the reference numeral 57.

The surface 571 is preferably arranged opposite to a surface 572 which faces the cover element 1.

1. A cover element of a battery module housing (2) configured to accommodate a plurality of battery cells (6), wherein the cover element (1) has a housing wall (7) with a first surface (8) and a second surface (9) arranged on an opposite side of the housing wall (7) from the first surface (8), and wherein the cover element (1) is configured such that, in a mounted state, the first surface (8) is arranged next to an environment (11) of the battery module housing (2) and the second surface (9) is arranged next to the battery cells (6) of the battery module, wherein
at least one electric element (12) or electronic element (13) is connected to the second surface (9) and/or at least one electric element (12) or electronic element (13) is integrated into the housing wall (7) of the cover element (1) such that components (15) of the least one electric element (12) or electronic element (13) are arranged on the second surface (9), characterized in that the housing wall (7) covers the at least one electric element (12) or electronic element (13) in a direction of the environment (11) in regions (16) of the first surface (8) which are arranged opposite regions of the second surface (9) that are covered by the at least one electric element (12) or electronic element (13).

2. The cover element of a battery module housing according to claim 1, characterized in that the at least one electric element (12) is a cell connector (34), a cell contacting element (39) or a busbar (32).

3. The cover element of a battery module housing according to claim 1, characterized in that the at least one electronic element (13) is a circuit board (33), a resistor conductor rail, a relay (31), an electromechanical component or a fuse (30).

4. The cover element of a battery module housing according to claim 1, characterized in that the cover element (1) has at least one voltage tap (19, 20), arranged on the first surface (8).

5. The cover element of a battery module housing according to claim 1, wherein the housing wall (7) has at least one opening (23), which is configured to receive a voltage tap (24, 25, 26) of a battery cell (6) of the battery module, characterized in that the at least one opening (23) is configured to be closed on sides of the first surface (8) by a covering member (27, 28, 29).

6. The cover element of a battery module housing according to claim 1, wherein the cover element (1) has a seal (38) arranged circumferentially on said cover element (1) and said cover element (1) is configured to be reversibly or irreversibly connected to the battery module housing (2) wherein in a mounted state, the seal (38) seals off an interior space that accommodates the battery cells (6) from the environment (11) of the battery module.

7. The cover element of a battery module housing according to claim 1, characterized in that a positioning element (41) is furthermore connected to the second surface (9), said positioning element being configured to attach the at least one electric element (12) or electronic element (13) to the second surface (9) by remelting the material of the positioning element (41).

8. The cover element of a battery module housing according to claim 1, wherein the cover element (1) has at least one attachment means (50) configured to attach the cover element (1) to the battery module housing (2), characterized in that the attachment means (50) is configured to be connected to the battery module housing (2).

9. A method for producing a battery module having a cover element according to claim 1, the method comprising
arranging the battery cells (6) in a battery housing (2) in a first step and,
in a second step, closing the battery housing (2) using the cover element (1) such that the battery cells (6) are electrically connected to one another in series and/or in parallel.

10. The method for producing a battery module according to claim 9, wherein the housing wall (7) has at least one opening (23), which is configured to receive a voltage tap (24, 25, 26) of a battery cell (6) of the battery module, and the at least one opening (23) is configured to be closed on sides of the first surface (8) by a covering member (27, 28, 29), and wherein the second step furthermore includes the accommodation of the voltage tap (24, 25, 26) of a battery cell (6) of the battery module in the at least one opening (23) and the voltage taps (24, 25, 26) are connected to cell connectors (34).

11. The method for producing a battery module according to claim 9, wherein the cover element (1) includes a positioning element (41) connected to the second surface (9), said positioning element being configured to attach the at least one electric element (12) electronic element (13) to the second surface (9) by remelting the material of the positioning element (41), and wherein, prior to the second step, the at least one electric element (12) or electronic element (13) is furthermore attached to the second surface (9) of the cover element (1), characterized in that the positioning element (41) for attaching the at least one electric element (12) or the at least one electronic element (13) to the second surface (9) is remelted, wherein the electric element (12) or respectively the electronic element (13) has at least one opening (42) and the positioning element (41), after the remelting process, furthermore has a first section (45) that is connected to the second surface (9), said first section being disposed in the opening (42) so as to extend and having a second section (46) connected to said first section (45), said second section being disposed outside of the opening (42) and at least partially contacting a surface (47) of the electric element (12) or respectively the electronic element (13).

12. The method for producing a battery module according to claim 9, wherein the cover element (1) is a cover element has at least one attachment means (50) configured to attach the cover element (1) to the battery module housing (2), characterized in that the attachment means (50) is configured to be connected to the battery module housing (2), and wherein, in the second step, the attachment means (50) of the cover element (1) continues to be connected to the battery module housing (2), characterized in that the connection is formed.

13. A battery module having a cover element according to claim 1.

14. A battery having a battery module according to claim 13.

15. The method for producing a battery module according to claim 9, wherein the cover element (1) has a seal (38) arranged circumferentially on said cover element (1) and said cover element (1) is configured to be reversibly or irreversibly connected to the battery module housing (2), wherein in a mounted state, the seal (38) seals off an interior space that accommodates the battery cells (6) from the environment (11) of the battery module, and wherein the second step furthermore includes the accommodation of the voltage tap (24, 25, 26) of a battery cell (6) of the battery module in the at least one opening (23) and the voltage taps (24, 25, 26) are connected to cell connectors (34).

16. The cover element of a battery module housing according to claim 1, characterized in that the cover element (1) has a positive voltage tap (20) and a negative voltage tap (19) arranged on the first surface (8).

17. The cover element of a battery module housing according to claim 1, wherein the housing wall (7) has at least one opening (23), which is configured to receive a voltage tap (24, 25, 26) of a battery cell (6) of the battery module, characterized in that the at least one opening (23) is configured to be closed on sides of the first surface (8) by a covering member (27, 28, 29), which is formed from an electrically insulating material or comprises an electrically insulating material.

18. The cover element of a battery module housing according to claim 1, wherein the cover element (1) has at least one attachment means (50), which is an opening (51), a projection (563) or a detent element (56), configured to attach the cover element (1) to the battery module housing (2), characterized in that the attachment means (50) is configured to be connected to the battery module housing (2).
